(19) United States
(12) Patent Application Publication
(10) Pub. No.: US 2021/0243561 A1
(43) Pub. Date: Aug. 5, 2021

(54) SYSTEM AND METHODS FOR TRACKING, LOCATING, AND SHARING PLASTIC PALLETS

(71) Applicant: Saudi Arabian Oil Company, Dhahran (SA)

(72) Inventors: Vincent Cunningham, Thuwal (SA); Haleema Alamri, Thuwal (SA)

(21) Appl. No.: 16/780,045

(22) Filed: Feb. 3, 2020

(51) Int. Cl. H04W 4/029; G06K 7/10; B65D 19/18; G06F 16/29; H04W 4/80

(52) U.S. Cl. CPC H04W 4/029; G06K 7/1097; H04W 4/80; G06F 16/29; B65D 19/18

(57) ABSTRACT

A pallet tracking system for tracking a plurality of uniquely identified pallets is provided. The pallet tracking system includes a non-transitory storage device and a tracking circuit. The non-transitory storage device is configured to maintain a pallet database of data concerning the pallets. The data concerning each pallet is accessible by the unique identifier of the pallet and includes a material composition of the pallet. The tracking circuit is configured to receive the unique identifier of one of the pallets from the one of the pallets using a scanning device, retrieve the material composition of the one of the pallets from the pallet database using the received unique identifier, and return the retrieved material composition in response to a request. A pallet sharing system for sharing the pallets with a plurality of custodians using this pallet tracking system is also provided.

### FIELD OF THE DISCLOSURE

The present disclosure relates in general to pallet technologies and more specifically to a plastic pallet tracking and locating system.

### BACKGROUND OF THE DISCLOSURE

Pallets play a major role in the economy of countries all over the world, such as for safely shipping, storing, and displaying goods. Traditional pallets are constructed of wood, come in a variety of sizes, such as 40 inches (in) by 48 in, and are relatively inexpensive to manufacture. Over time, however, wooden pallets are subject to wear, such as loose or broken boards, and protruding nails. As such, repairs and maintenance are needed to extend the lifetime of wooden pallets. Plastic pallets, on the other hand, are more durable, can handle heavier loads, and are less susceptible to environmental and weather conditions, especially water. By contrast, in wooden pallets, moisture absorbed by the wood can also to rot, infestation, and bacteria growth. The amount of trips a plastic pallet can withstand is about 250 times that of a wooden pallet. Plastic pallets are also significantly easier to sanitize between uses.

With advances in durability and reduced cost of plastic materials, there is a growing trend towards the use of plastic materials for constructing pallets. Plastic pallets have a number of benefits over their wooden equivalents. For example, compared to wooden pallets, plastic pallets can be reused for longer periods of time, are not susceptible to bacteria, require no treatment for warehouse storage, are lighter weight, and are splinter free. However, there are also drawbacks to plastic pallets compared to their wooden counterparts. These include higher manufacturing cost and lower environmental degradability. Such drawbacks are compounded by the general inexpensive or throwaway perception of wooden pallets.

It is in regard to these and other problems in the art that the present disclosure is directed to provide a technical solution for an effective plastic pallet tracking and locating system.

### SUMMARY OF THE DISCLOSURE

According to an embodiment, a pallet tracking system for tracking a plurality of uniquely identified pallets is provided. The pallet tracking system comprises: a non-transitory storage device configured to maintain a pallet database of data concerning the pallets, the data concerning each pallet being accessible by the unique identifier of the pallet and comprising a material composition of the pallet; and a tracking circuit configured to receive the unique identifier of one of the pallets from the one of the pallets using a scanning device, retrieve the material composition of the one of the pallets from the pallet database using the received unique identifier, and return the retrieved material composition in response to a request.

In an embodiment: the one of the pallets comprises a radio-frequency identification (RFID) tracking device embedded in the one of the pallets and configured to transmit the unique identifier of the one of the pallets; and the scanning device is configured to receive the transmitted unique identifier from the RFID tracking device.

In an embodiment: the one of the pallets comprises the unique identifier embedded in the one of the pallets; and the scanning device is configured to scan the embedded unique identifier using a line-of-sight scanner that scans reflected electromagnetic radiation off the embedded unique identifier in the visible or near visible spectrums.

In an embodiment, the data concerning the pallets comprises: a first unique identifier whose material composition is a first plastic; and a second unique identifier whose material composition is a second plastic different from the first plastic.

In an embodiment, the data concerning the pallets comprises: a first unique identifier whose material composition is a first plastic composite; and a second unique identifier whose material composition is a second plastic composite different from the first plastic composite.

In an embodiment: the data concerning each pallet further comprises a location of the pallet; and the tracking circuit is further configured to receive the unique identifier and a present location of the one of the pallets from the one of the pallets using the scanning device, and update the location of the one of the pallets to the received present location in the pallet database using the received unique identifier.

In an embodiment: the data concerning each pallet further comprises a location history of the pallet; and the tracking circuit is further configured to update the location history of the one of the pallets in response to the received present location.

In an embodiment: the one of the pallets comprises a radio navigation-satellite service (RNSS) tracking device embedded in the one of the pallets and configured to transmit the unique identifier and the present location of the one of the pallets; and the scanning device is configured to receive the transmitted unique identifier and present location from the RNSS tracking device.

In an embodiment, a pallet sharing system for sharing the pallets with a plurality of custodians using the pallet tracking system is provided. In the pallet sharing system: the plurality of custodians comprises a first custodian and a second custodian; the data concerning each pallet further comprises an availability indicator and a custodian of the pallet from among the plurality of custodians; and the tracking circuit is further configured to receive the unique identifier and a request to check in the one of the pallets on behalf of the first custodian from the one of the pallets using the scanning device when the pallet database indicates the one of the pallets is unavailable and the custodian of the one of the pallets is the first custodian, update the data concerning the one of the pallets to indicate the one of the pallets is available in the pallet database using the received unique identifier in response to the check-in request, receive the unique identifier and a request to check out the one of the pallets on behalf of the second custodian from the one of the pallets using the scanning device when the pallet database indicates the one of the pallets is available, and update the data concerning the one of the pallets to indicate the one of the pallets is unavailable and the custodian is the second custodian in the pallet database using the received unique identifier in response to the checkout request.

In an embodiment: the data concerning each pallet further comprises a custodial history of the pallet; and the tracking circuit is further configured to update the custodial history of the one of the pallets in response to at least one of the check-in request and the checkout request.

According to another embodiment, an automated pallet tracking method for tracking a plurality of uniquely identified pallets is provided. The pallet tracking method comprises: maintaining, on a non-transitory storage medium, a pallet database of data concerning the pallets, the data concerning each pallet being accessible by the unique identifier of the pallet and comprising a material composition of the pallet; receiving, by a tracking circuit, the unique identifier of one of the pallets from the one of the pallets using a scanning device; retrieving, by the tracking circuit, the material composition of the one of the pallets from the pallet database using the received unique identifier; and returning, by the tracking circuit, the retrieved material composition in response to a request.

In an embodiment, the one of the pallets comprises a radio-frequency identification (RFID) tracking device embedded in the one of the pallets, and the pallet tracking method further comprises: transmitting, by the RFID tracking device, the unique identifier of the one of the pallets; and receiving, by the scanning device, the transmitted unique identifier from the RFID tracking device.

In an embodiment: the one of the pallets comprises the unique identifier embedded in the one of the pallets; and the pallet tracking method further comprises scanning, by the scanning device, the embedded unique identifier using a line-of-sight scanner that scans reflected electromagnetic radiation off the embedded unique identifier in the visible or near visible spectrums.

In an embodiment, the data concerning the pallets comprises: a first unique identifier whose material composition is a first plastic; and a second unique identifier whose material composition is a second plastic different from the first plastic.

In an embodiment, the data concerning the pallets comprises: a first unique identifier whose material composition is a first plastic composite; and a second unique identifier whose material composition is a second plastic composite different from the first plastic composite.

In an embodiment, the data concerning each pallet further comprises a location of the pallet, and the pallet tracking method further comprises: receiving, by the tracking circuit, the unique identifier and a present location of the one of the pallets from the one of the pallets using the scanning device; and updating, by the tracking circuit, the location of the one of the pallets to the received present location in the pallet database using the received unique identifier.

In an embodiment: the data concerning each pallet further comprises a location history of the pallet; and the pallet tracking method further comprises updating, by the tracking circuit, the location history of the one of the pallets in response to the received present location.

In an embodiment, the one of the pallets comprises a radio navigation-satellite service (RNSS) tracking device embedded in the one of the pallets, and the pallet tracking method further comprises: transmitting, by the RNSS tracking device, the unique identifier and the present location of the one of the pallets; and receiving, by the scanning device, the transmitted unique identifier and present location from the RNSS tracking device.

In an embodiment, a pallet sharing method for sharing the pallets with a plurality of custodians using the pallet tracking method is provided. In the pallet sharing method: the plurality of custodians comprises a first custodian and a second custodian; the data concerning each pallet further comprises an availability indicator and a custodian of the pallet from among the plurality of custodians. The pallet sharing method comprises: receiving, by the tracking circuit, the unique identifier and a request to check in the one of the pallets on behalf of the first custodian from the one of the pallets using the scanning device when the pallet database indicates the one of the pallets is unavailable and the custodian of the one of the pallets is the first custodian; updating, by the tracking circuit, the data concerning the one of the pallets to indicate the one of the pallets is available in the pallet database using the received unique identifier in response to the check-in request; receiving, by the tracking circuit, the unique identifier and a request to check out the one of the pallets on behalf of the second custodian from the one of the pallets using the scanning device when the pallet database indicates the one of the pallets is available; and updating, by the tracking circuit, the data concerning the one of the pallets to indicate the one of the pallets is unavailable and the custodian is the second custodian in the pallet database using the received unique identifier in response to the checkout request.

In an embodiment: the data concerning each pallet further comprises a custodial history of the pallet; and the pallet sharing method further comprises updating, by the tracking circuit, the custodial history of the one of the pallets in response to at least one of the check-in request and the checkout request.

Any combinations of the various embodiments and implementations disclosed herein can be used. These and other aspects and features can be appreciated from the following description of certain embodiments together with the accompanying drawings and claims.

### BRIEF DESCRIPTION OF THE DRAWINGS

FIG. 1 is a schematic diagram of an example plastic pallet tracking and locating system, according to an embodiment.

FIG. 2 is an oblique view of a couple of example plastic pallets having embedded tracking devices, suitable for use with a plastic pallet tracking and locating system such as the plastic pallet tracking and locating system of FIG. 1, according to an embodiment.

FIGS. 3A through 3D are illustrations of possible coding schemes and coding locations for plastic pallets, suitable for use with a plastic pallet tracking and locating system such as the plastic pallet tracking and locating system of FIG. 1, according to embodiments.

FIG. 4 is an oblique view of three example plastic pallets having different combinations of embedded tracking devices and pallet coded systems, suitable for use with a plastic pallet tracking and locating system such as the plastic pallet tracking and locating system of FIG. 1, according to an embodiment.

FIG. 5 is a flow diagram of an example automated pallet tracking method for tracking a plurality of uniquely identified pallets, according to an embodiment.

FIG. 6 is a flow diagram of an example automated pallet sharing method for sharing uniquely identified pallets with a plurality of custodians, according to an embodiment.

It is noted that the drawings are illustrative and not necessarily to scale, and that the same or similar features have the same or similar reference numerals throughout.

### DETAILED DESCRIPTION OF CERTAIN EMBODIMENTS OF THE DISCLOSURE

In various example embodiments, a plastic pallet tracking and locating system is provided. The system is used in conjunction with identification technology on or in pallets to ensure accurate tracking of the pallets and to increase or maximize their utilization and safety. The development of composite materials for plastic pallets provides for cost-effective replacement of wooden pallets. Such pallets are high performance, recyclable, and durable. Various pallets, including plastic pallets, that are to be tracked or located by the system are first coded or otherwise identified. This allows the system to track or associate useful information related to the pallet, such as the material or composition of the pallet, its usage history, its condition, its owner, and the like. To this end, the system is configured to track such identified pallets throughout their use, including their present location, their present environment, their present owner or responsible party, and their present task. The system is further configured to help locate lost pallets, provide statistics on their use, and encourage proper use of pallets by their handlers. In some such embodiments, the system is further configured to provide information on the pallet health (e.g., tied to historical behavior) and on the goods being transported, stored, or displayed.

As discussed earlier, plastic pallets have a higher cost and lower environmental degradability than traditional wooden pallets. For example, plastic pallets can cost 10 (or more) times as much as wooden pallets, and decompose at a fraction of the rate of wooden pallets when disposed (e.g., in a landfill). In addition, the general inexpensive and throwaway mindset of using wooden pallets permeates to more durable and expensive pallets, such as plastic pallets. This leads to significant loss (e.g., misplacing, abandoning, theft, disposing) of such pallets before end of life. Without adequate reuse and recycling, the benefits of pallets made from fancier materials (such as plastic) cannot be appreciated. This impedes more widespread use of such pallets. The amount of trips a plastic pallet can withstand is 250 (or more) times that of a wooden pallet. If full advantage could be taken of this increased lifespan, the cost comparison between wooden and plastic pallets would sway in favor of plastic. However, the number of trips that plastic pallets are capable of making under actual conditions is significantly fewer, due to the high loss rate of plastic pallets. Compounding this loss rate is the lack of accurate statistics on the use and disposal of plastic pallets, which thwarts efforts to make better use of such pallets.

Accordingly, and in example embodiments, a method for plastic pallet tracking and locating is provided. The method further advances the development of composite materials for plastic pallets as a replacement for wood pallets. Over time, such plastic pallets can achieve lower cost, higher performance, better recyclability, and more durability (e.g., from new plastic and composite materials) compared to their wooden counterparts. In some such embodiments, the method includes steps oriented around pallet sharing, including maintaining a pool of pallets that are rented out or loaned as needed to users and returned to the pool when not needed. Such a pallet sharing method leads to increased use and reuse of plastic and plastic composite pallets, helps make such plastic pallets economically viable with respect to wooden pallets. In such embodiments, a pallet sharing platform from enables a pool of pallets to be shared and maintained among numerous users.

All methods in accordance with the present disclosure provide for pallet tracking and monitoring, such as to reduce or prevent theft of the pallets. The disclosed methods further provide for enhanced operational lifetime of the pallets though health monitoring, such as monitored and maintained maintenance records, inspections, and repairs of the pallets.

In further detail, the plastic pallet tracking and locating method includes one or more identification technologies embedded in, attached to, or otherwise associated with the pallets. This allows the pallets to be tracked and their health monitored. The method increases or maximizes the use of plastic pallets. The method enhances the use of plastic pallets and reduces the lifecycle costs of plastic pallets by introducing or exploiting technologies to identify, track, and locate pallets, including plastic pallets. These technologies can also be used to monitor the health of pallets and provide valuable information on the corresponding goods being transported, stored, or displayed using the pallets. In an embodiment, the method tracks the location of lost/stolen/misplaced pallets (of any material) using Global Positioning System (GPS) or similar satellite-based positioning or radio navigation-satellite service (RNSS) technology. In another embodiment, the method tracks the location of pallets by scanning a unique identifier of the pallet (e.g., at various points along a pallet's movement or storage), with the method updating the location of the pallet in the pallet database based on the location of the scanning device.

In an embodiment, a plastic pallet tracking and locating system is configured to provide automated storage and management with respect to pallet sharing or pallet exchanging. The system is configured by code which, for instance, is provided from a non-volatile memory for execution in a hardware processor (as used herein, more concisely, “configured by code” or sometimes just “configured”). The system so-configured includes smart pallets in order to enhance or automate storage at packaging facilities and logistic centers. By “smart,” it is meant that the pallets, for example, have tracking devices or unique encodings embedded in or securely attached to the pallets in order to facilitate identification and tracking of the pallets. Using such an identification system, the plastic pallet tracking and locating system is further configured to provide a fully automated logistics pallet exchange facility. With such a process, the pallet tracking and locating system is further configured to provide a user interface to allow users to check out pallets from and check in pallets to one of a number of pallet storage facilities located at strategically placed locations (e.g., industrial parks, logistic centers, ports, and the like).

By providing an automated platform from which to provide pallet sharing and pallet exchanging, the human interaction for the process can be limited while the history and users of pallets can be known at all times. In addition, the automated pallet sharing and pallet exchanging platform is further configured to monitor the availability of pallets within the pallet pools, and to provide information on when pallet pools need to be replenished or when they are overstocked. By gathering information from all the storage facilities, the automated pallet sharing and pallet exchanging system is further configured to provide information on how to redistribute pallets between locations in order to improve or optimize the pallet volume at each location. The storage of pallets is an important concern, given the size (volume) taken up by the pallets in a facility. In some embodiments, the automated pallet sharing and pallet exchanging system is further configured to analyze the use of pallets over time and predict the usage of pallets as well as improve or optimize their storage, repair, washing/cleaning, and recycling cycles. This helps ensure that there is always sufficient high quality pallets available to users.

In various embodiments, identification technologies (e.g., tracking devices, identification codes, and the like) are embedded in pallets, such as installing the corresponding codes (of a pallet coding system) on or in the pallets during their manufacture. The embedded technologies provide physical protection to the identifiers while allowing the pallets to be tracked and their health or condition monitored. In some such embodiments, a Quick Response (QR) code, barcode, numeric code, alphanumeric code, or the like is embedded (e.g., 3D printed or otherwise integrally formed) in each pallet during manufacture. This does not add parts to the pallet, protects the code from normal wear and tear, and can perform a role similar to that of radio-frequency identification (RFID) tagging in other tracking technologies. In various embodiments, a plastic pallet tracking and locating system is programmed or otherwise configured to maintain (e.g., in a pallet database) pallet attributes related to smart storage facilities and logistic centers. In various embodiments, a plastic pallet tracking and locating system is configured to maintain, and provide a user interface to, a pallet sharing platform in order to allow more use from and more efficiently use pallets.

In various embodiments, a plastic pallet tracking and locating system is configured to maintain (e.g., in a pallet database), and provide access to, information on pallet material (e.g., composite, plastic, wood, and the like) for each pallet, such as for recycling purposes or matching the most appropriate pallet to the corresponding task. In some such embodiments, the pallet material information maintained in the pallet database is more specific, such as type of plastic or type of composite (e.g., plastic composite, constituent materials, structure, matrix material, and the like), and properties of the materials (e.g., load strength, durability, maintenance needs, to name a few). In some such embodiments, pallets having different plastic materials (e.g., HDPE, PETE) are maintained and distinguished within the pallet database. In some other such embodiments, pallets having different plastic composite materials are maintained and distinguished within the pallet database. In various embodiments, a plastic pallet tracking and locating system is configured to maintain (e.g., in a pallet database), and provide access to, information on pallet health (e.g., age, number of uses, damage, and the like).

In further embodiments, a plastic pallet tracking and locating system is configured to maintain and provide information related to a pallet's material composition. This can be especially useful in the area of recycling, where the system should be configured to maintain and provide information on a pallet's material composition with sufficient specificity to identify which recycling plants or facilities are capable of processing it. Through the use of specially designed composite materials, most of the downfalls or weaknesses associated with plastic pallets can be overcome. The composite materials can be designed to add the required strength and flexibility to enhance the lifetime and value of the pallet. It should be noted that pallets can be specially designed using different compounds or materials designed for specific applications, such as where more strength is required, more malleability is needed, or the like.

With this in mind, in some embodiments, a pallet tracking and locating system includes maintaining and providing sufficient information on the pallet material composition to allow the correct recycling process to be undertaken. A large part of the theft associated with plastic pallets is due to their plastic value (e.g., money return at recycling plants). However, with composite pallets this theft is less likely as specific plants and processes are required for recycling (e.g., depending on the materials, structure, process, and the like). With this level of information on the pallet composition, the users/owners can determine which recycling plants to bring the pallets for proper recycling, and the data concerning the plastic materials used in a given pallet is available for use in sorting pallets when they are at the end of their respective service life and are ready for recycling.

The benefits and advantages of using plastic pallets instead of their wooden equivalents include longer reuse periods (e.g., 20 or more times longer), lighter weight (e.g., 10 or more times lighter), and more trips (e.g., 250 or more times as many trips). In addition, plastic pallets can be formed in single pieces, and with more uniform or ergonomic shapes than possible with wood. In example embodiments, a plastic pallet tracking and locating system addresses the higher cost of plastic pallets over wooden pallets by making it practical to reuse plastic pallets a sufficient number of times to recoup their extra production cost. In some such embodiments, the system is further configured to reduce or minimize the disposal or recycling costs associated with plastic pallets (e.g., by increasing or maximizing their intended use).

In an embodiment, a process to monitor and track pallets is provided. The pallets are tracked or identified through the application of tracking and identification technologies into or on the pallets, such as during (or right after) manufacture of the pallets. The monitoring and tracking process is automated, such as configured through applications running on a computer processor, with the applications being programmed or coded to monitor the pallets. The process provides for pallet sharing (among numerous users within a pool of pallets). The process also provides for locating missing pallets (e.g., loss, theft, misplaced, or the like) using tracking technology such as GPS tracking. The process also provides information on the health (e.g., use and maintenance over time) of the pallets. In addition, the process provides information on the materials used to make the pallets, such as for use in recycling the pallets when they reach their end of life. The process further provides for an embedded permanent coded system (e.g., QR codes, barcodes, numeric codes, alphanumeric codes, and the like) during manufacture in order to uniquely identify the pallets when in use. This further helps facilitate the tracking and locating of the pallets throughout their use.

In an embodiment, a pallet tracking system is implemented as software configured to execute on a computer or other electronic processing device, such as an online application (app) or purpose-developed application for a laptop computer, a tablet device, or a smartphone. The system is configured (e.g., programmed) to provide an interface (such as a user interface like a graphical user interface or GUI) to sign pallets in and out of an inventory. This signing in and out (e.g., registration) process for the pallets can include additional information, such as the load or intended use of the pallet(s). In some embodiments, the registration is applied to both plastic and wooden pallets (or any other pallet material).

In an embodiment, a pallet tracking system is based on a short message service (SMS) messaging system to sign in/out (e.g., register) pallets. The pallet materials can include composite, plastic, wooden, or any other pallet material (such as metal or engineered paper). In an embodiment, a pallet tracking system is based on code scanning, such as a Quick Response (QR) code or barcode. The codes can be applied to, for example, composite, plastic, and wooden pallets (or any other pallet material). In some embodiments, the pallet tracking system is based on an embedded Global Positioning System (GPS) tracking device or locator in the pallet. The locator can be applied to pallets of a variety of types, including composite, plastic, and wooden pallets (or any other pallet material). The locator can help prevent loss of the pallet and provide location information of the pallet. This can be an ideal solution for the location of missing, stolen, or lost pallets that are not nearby.

In an embodiment, a pallet tracking system is based on one or more embedded radio-frequency identification (RFID) tags in the pallet to identify pallets. The tag or tags can be applied to composite, plastic, and wooden pallets (or any other pallet material). Passive RFID tags (e.g., that transmit identifying information in response to being activated by a nearby scanner) can provide, for example, pallet location and automated input of information into databases. It should be noted that the pallet needs to be within range (such as within 5 meters) of the scanning device, depending on factors such as the scanner or location of the RFID tag. In an embodiment, a pallet tracking system is based on embedded location devices (such as embedded GPS devices) in the pallets.

Other pallet attributes can also be maintained by the pallet tracking system using RFID tracking. For instance, information on pallet quality control after manufacture (e.g., number of uses, present condition, repair or maintenance history, and the like) can be maintained by the pallet tracking system. In addition, information on pallet material (e.g., composite, plastic, wooden, or any other material) that is important for operations such as recycling and cleaning can be maintained by the pallet tracking system. Further, information on pallet contents or load as well as pallet location can be maintained by the pallet tracking system. This information can be useful, for example, to enhance automated storage facilities, packaging facilities, and logistic centers.

In some embodiments, a plastic pallet tracking and locating system is configured by code to maintain this pallet contents/load/goods information to help autonomous robots collect pallets containing products and move them for further processing, such as for automated packing and shipping logistics centers. In some such embodiments, the pallet tracking and locating system is configured by code to track the corresponding goods on the pallets by maintaining a correspondence between the pallets and their goods in a pallet database, and by tracking and locating the pallets while the goods are still on the pallets.

Aspects of the above-described embodiments can be combined to produce further embodiments. For example, in some embodiments, any of the above-described embodiments can be configured in a pallet tracking system to monitor pallet properties, such as age, number of trips, distance travelled, location of pallet, custodian/responsible party for the pallet, and the like. Similarly, in some embodiments, any of the above-described embodiments can be configured in a pallet tracking system to monitor data associated with pallet transportation and storage, such as product information being transported/stored/displayed, product time on the pallet, and the like. Likewise, in some embodiments, any of the above-described embodiments can be configured in a pallet tracking system to set up a pallet sharing platform to further extend the use of a single pallet, such as by creating a shared pool of pallets for numerous customers or custodians, checking out and returning each pallet as needed.

In some embodiments, any of the above-described embodiments can be configured in a pallet tracking system to identify the health of the pallet, such as the number of times used, number of times cleaned, number of times repaired, and the pallet's age/date manufactured, to name a few. In some embodiments, any of the above-described embodiments can be configured in a pallet tracking system to identify the pallet material, such as to assist in pallet recycling (e.g., composite materials, plastic materials, metal materials, and so on, have different recycling processes) or matching the appropriate pallet to the task at hand. In some embodiments, any of the above-described embodiments can be configured in a pallet tracking system for applications related to enhancing automated storage, packaging facilities, and logistic centers. For instance, in some embodiments, a pallet tracking system is configured to control autonomous robots in the collection of pallets containing products and in the movement of these pallets (and corresponding products) for further processing. Such a pallet tacking system can be used, for example, in an automated logistics center.

In some embodiments, a pallet tracking system is configured to use information gathered from a pallet database to determine logistics for pallet distribution. For instance, the pallet tracking system can be configured by code to use the pallet database to determine where pallets are checked out, where they are checked in, and to manage the redistribution of pallets from where they are checked in to where they are checked out in order to enhance the usage of the pallets. In some embodiments, a pallet tracking system is configured by code to register users and locations of pallets in order to assist in the recovery of stolen or misplaced pallets.

In some embodiments, a pallet tracking system is configured by code to operate with pallets using embedded identification and tracking technologies. For example, in one such embodiment, the pallet tracking system is further configured by code to be a pallet sharing platform in order to enhance pallet use. In some such embodiments, this pallet sharing platform is deployed within a single facility (e.g., manufacturing plant, oil refinery, or the like) that uses pallets. In some other such embodiments, this pallet sharing platform is deployed across numerous dispersed facilities, practicing external sharing facilitated by pallet storage facilities. In some embodiments, a pallet tracking system is configured by code to manage pallets having an embedded tracking code (e.g., QR code, barcode, proprietary coding system, numeric, alphanumeric, and the like). For instance, the tracking codes can be embedded in the pallets during manufacture (e.g., using 3D printing), with no additional electronic or electrical parts required. This helps reduce the cost associated with tracking codes, as they are embedded during pallet manufacture, when consistent access to pallets at the appropriate stage of construction is maximal and the cost of the additional step is minimal (e.g., on a per pallet basis).

The deployment of plastic pallets is limited much of the time due to their higher up front cost. Even though the use of wireless tracking technologies, such as RFID, local area network (LAN), or GPS (or similar RNSS) is highly advantageous at being able to track and locate appropriately equipped pallets, it does add to the overall cost of the pallet. This can be reduced significantly if instead a uniquely identifying coding system is deployed on the pallet during manufacture (e.g., through molding, 3D printing, or the like) or using specific tools to brand pallets with a unique code/pattern after fabrication.

The coding system is capable of being electronically scanned by a corresponding electronic scanning device (e.g., QR scanner, barcode scanner) configured to scan for the particular coding system. A unique identifier code, which could be, for example, a pattern (e.g., similar to a QR Code or barcode), a sequence of numbers, or a sequence of numbers, letters, and symbols can be used in place of RFID (or other similar tracking technologies). In an embodiment, a plastic pallet tracking and locating system is configured to connect these unique codes or patterns to a pallet database containing all the information on the corresponding pallets and their usage histories. As such, in some embodiments, the pallet tracking and locating system is further configured to provide a user interface to update, maintain, and provide information about the corresponding pallets in response to requests from the users, including automated scan requests from scanning devices used to track the pallets.

The consistency and automated nature of plastic pallet construction as well as the materials used make them an ideal platform to embed tracking and identification technologies. In example embodiments, plastic pallets are managed by a plastic pallet tracking and locating system configured to exploit such embedded tracking tools. The tracking and identification technologies include, for example, coded patterns (e.g., QR codes, bar codes), GPS technologies for location, RFID for identification, and unique numeric/alphanumeric codes. By combining one or more of these tracking and identification technologies with a computing system and purpose-built software applications, the plastic pallet tracking and locating system is configured to let owners and users track the location of their pallets at all times (e.g., real time use). The system is further configured to track and provide other valuable information (metrics) regarding, for example, the health of the pallets, number of times cleaned, number of trips, cargo, origin, destination, and load (e.g., empty or full). Similarly, the system is further configured to manage the responsibility of the pallets, such as by providing a user interface to easily assign the pallets to the various users or other custodians of the pallets.

In some embodiments, to further enhance the use of plastic pallets, a plastic pallet tracking and locating system having a sharing platform is provided. The sharing platform is used in conjunction with suitably identified pallets and a network of strategically located pallet storage facilities. The storage facilities are distributed in places of large pallet use, such as industrial parks, warehouses, and the like. The storage facilities can be accessed by different users (such as registered members or casual/occasional users) for short or long term rental of the pallets.

In one such embodiment, the pallet tracking and locating system is configured to supply users with a scanning interface. When an identification (e.g., coded pattern) of one the pallets belonging to the pool is scanned by a user, the scanning interface (e.g., through a display device, such as a laptop, smartphone, or smart scanner) provides the user with knowledge of, for example, the age, use, and status/condition of the pallet being scanned. To this end, the pallet tracking and locating system has a tracking circuit (e.g., processor, microprocessor, custom logic, FPGA) configured to receive the scanned identity of the pallet, and retrieve or update the corresponding record in a pallet database for the pallet having that identity. The scanning interface can further be programmed to provide any trackable data relating to the pallet and that is stored in the pallet database, such as the pallet material, availability, or specifications of the pallet. Such a system can attract new users of pallets, improve branding and image, and generate investment in local industries (e.g., development of new products and services, such as pallet cleaning and maintenance).

While plastic pallets provide a lot of benefits over traditional wooden pallets, they also cost significantly more to produce. As a result, they are more prone to unlawful acquisition such as theft. In part, this is due to the valuable nature of the plastic material that can be exchanged for cash at recycling plants. Embedded technologies as discussed in embodiments throughout can provide information on, for example, the custodian and location of pallets, which helps deter theft and enhance the pallet's user/responsible awareness and care of the pallet. Governmental legislation can also make it criminal for recycling operations to accept such pallets for recycling except from the actual owners of them (e.g., similar to how junkyards or wrecking yards can only accept automobiles from their owners).

In some embodiments, a pallet tracking and locating system includes a purpose built platform (e.g., a computer or other electronic processing device configured by code, such as a tracking circuit) to record valuable information in order to ensure the maintenance and use of pallets and also to provide additional metrics on their performance. As a non-limiting list, example metrics/properties of the pallets include: user (e.g., sole user/company, source user/company, destination user/company), age of the pallet (e.g., manufactured date, remaining lifetime), number of trips (e.g., daily, monthly, during total lifespan), distance travelled, geographical location, and the like. There can also be interfaces to the pallets (e.g., through their unique identifiers and the pallet database) configured to identify areas of storage facilities (e.g., for pallet sharing), to locate pallets (e.g., in case of loss or theft), and to provide information on common routes and pallet composition (e.g., composite, plastic, wooden, or other essential information for recycling). In some such embodiments, the pallet tracking and locating system is further configured to identify the cargo (e.g., through manual input, or scanning of a cargo-coded system).

Such cargo identifications can be used to provide metrics on delivery quantities, destinations, and the like. Such cargo identifications can also serve as an additional means to track (or confirm the tracking of) items associated with the pallet (e.g., similar to the way products themselves are identified, scanned, and tracked in transit).

In some example embodiments, the tracking logic is implemented as computer code configured to be executed on a computing circuit (such as a microprocessor) to perform the tracking and locating steps that are part of the technique. For ease of description, this processing logic (e.g., ASIC, FPGA, processor, custom circuit, or the like) is referred to as a tracking circuit throughout. For further ease of description, this tracking circuit or locating circuit is programmable by code to perform the tracking logic or locating logic (or otherwise customize the circuit to perform its intended purpose).

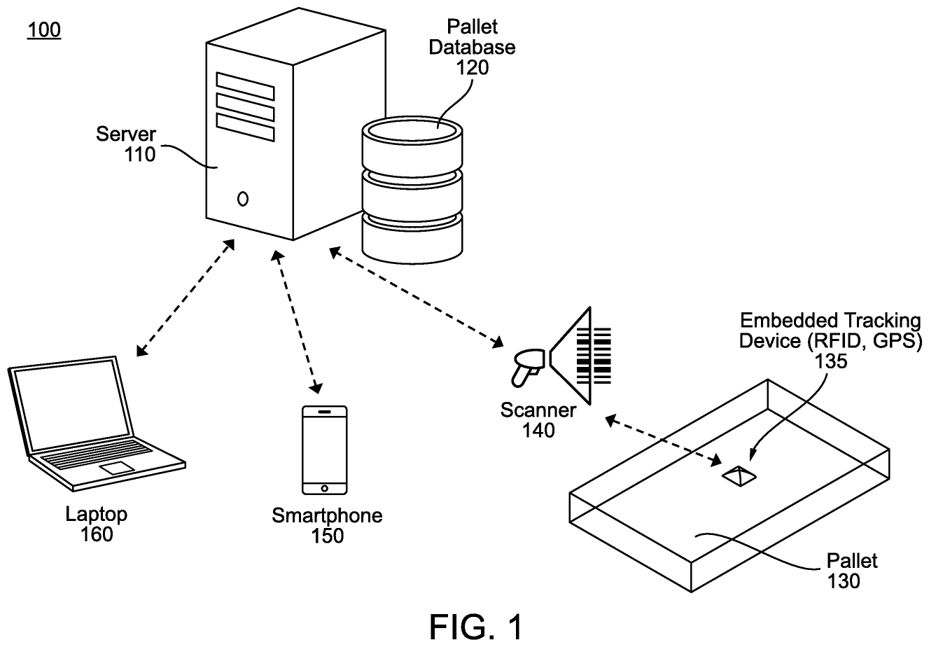

Referring now to FIG. 1, a schematic diagram illustrates an example plastic pallet tracking and locating system 100 according to an embodiment. The system 100 includes a server 110 (or server computer) configured (e.g., by code) to automatically perform many of the tracking and locating tasks described herein. The server 110 is but an example electronic computation device. In other embodiments, different computing devices can be used, such as a workstation computer, a desktop computer, a laptop computer (or laptop), a tablet computer (or tablet), a smartphone, a cloud computing device (or other virtual computing device), to name a few. The computing device is configured, such as with computer instructions or code, software or firmware logic, custom logic, or the like, to carry out the tasks assigned to the computing device.

The system 100 further includes a pallet database 120, such as a database stored on a non-transitory storage device (e.g., disk drive, flash memory or flash drive). The pallet database 120 is used to store and maintain information about a set of pallets 130 managed by the system 100. For example, in one embodiment, the server 110 is programmed or otherwise configured to maintain the size (dimensions), material (composition), location, and responsible party (custodian) of each pallet 130 managed by the system 100 in the pallet database 120. Size, material, location, and custodian are but example pallet attributes, and in this and other embodiments, the server 110 is further programmed or otherwise configured to maintain a combination of further pallet attributes (such as other pallet attributes disclosed herein) for each pallet 130 in the pallet database 120.

Each pallet 130 being managed by the system 100 is uniquely identified (e.g., unique identifier, unique numeric or alphanumeric coding) in some way that can be electronically recognized. For instance, the pallet 130 in FIG. 1 includes an embedded tracking device 135 (e.g., RFID, GPS circuit, or the like) to allow identification of the pallet 130. In some embodiments, a scanning device or scanner 140 (such as an RFID scanner) is used to scan the tracking device 135 in order to uniquely identify (e.g., obtain a unique identifier of) the pallet 130. For example, in one embodiment, the scanner 140 is in electronic communication with the server 110 and pallet database 120 and uses the scanned identification to communicate or update the status of the pallet 130 as maintained in the pallet database 120. The server 110 receives the unique identifier of the pallet from the scanner 140 together with a request (e.g., retrieve or update a field) of the pallet database 120. In one embodiment, for a retrieve request, the server 110 looks up the pallet database 120 by the unique identifier of the pallet requested, and returns the field value (e.g., dimensions, material composition, availability, or the like) requested for the pallet having that unique identifier.

The server 110 is further programmed or otherwise configured to provide user interfaces to the pallet database 120, such as through applications (apps) on smaller or more portable devices. For instance, in one embodiment, personal computing devices such as a smartphone 150 or a laptop 160 are configured (e.g., programmed) to interface with the pallet database 120 through the server 110. This can be useful, for example, to determine the location or disposition of any of the pallets 130 maintained by the system 100. Laptops and smartphones are but example user interface devices, and in other embodiments, other user devices (e.g., tablets, workstations, desktop computers, or the like) are configured to interface with the pallet database 120 through the server 110.

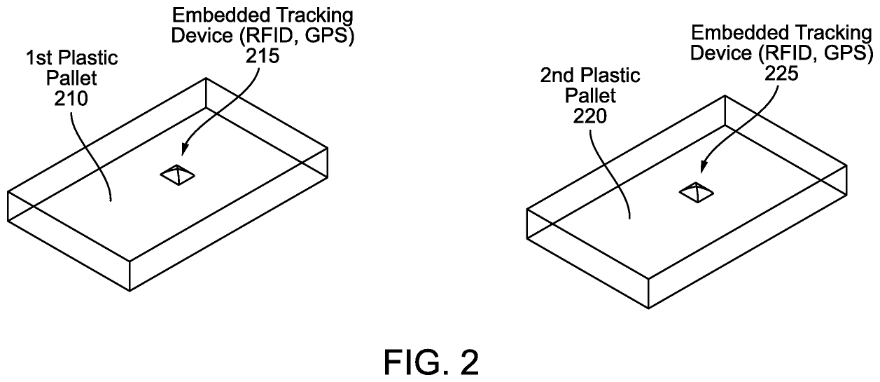

FIG. 2 is an oblique view of a couple of example plastic pallets 210 and 220 having embedded tracking devices 215 and 225, respectively, suitable for use with a plastic pallet tracking and locating system such as the plastic pallet tracking and locating system 100 of FIG. 1, according to an embodiment. For example, in one embodiment, RFID tags 215 and 225 are embedded in the pallet matrix of a first plastic pallet 210 and a second plastic pallet 220, respectively, during construction. The plastic pallet matrix material, such as high-density polyethylene (HDPE) or recycled polyethylene terephthalate (PET or PETE), is reasonably transparent to RFID radio waves, allowing the embedded RFID tags 215 and 225 to be scanned (e.g., by an RFID scanner) throughout use. In addition, having the RFID tags 215 and 225 embedded in the plastic pallets 210 and 220 makes their removal complicated without damaging the pallets 210 and 220. This helps with the security and reliability of the tracking system.

In other embodiments, GPS systems/chips are embedded in the pallets during the manufacturing process, similar to the RFID tags described above. This, too, helps prevent theft or removal of (or damage to) the sensing technology.

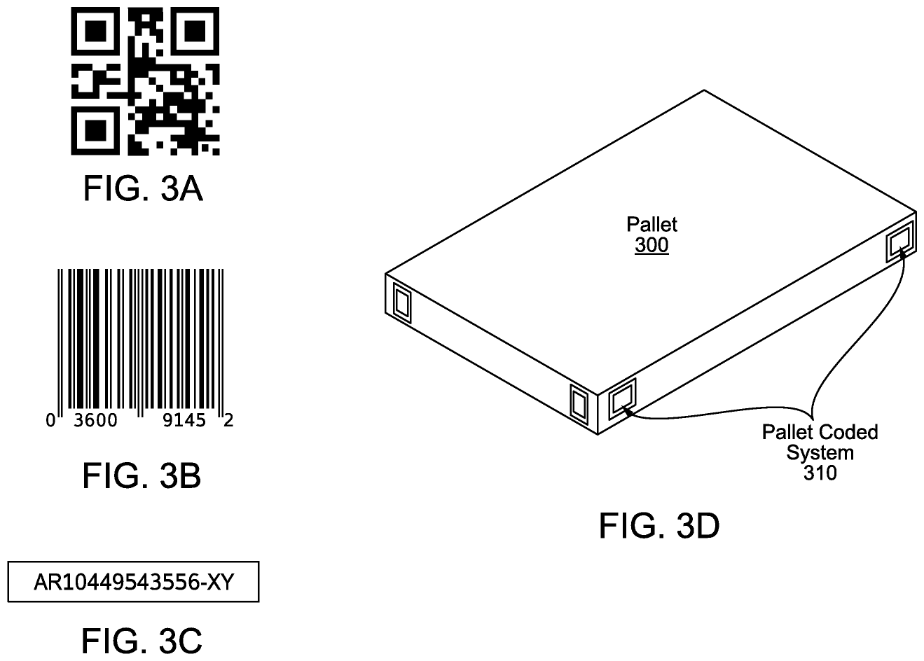

FIGS. 3A through 3D are illustrations of possible coding schemes and coding locations for plastic pallets, suitable for use with a plastic pallet tracking and locating system such as the plastic pallet tracking and locating system 100 of FIG. 1, according to embodiments. For example, FIG. 3A illustrates an example QR code for coding a plastic pallet, FIG. 3B illustrates an example barcode for coding a plastic pallet, and FIG. 3C illustrates an example alphanumeric code for coding a plastic pallet. FIG. 3D illustrates possible coding locations 310 on a plastic pallet 300 for a pallet coded system. In this case, the pallet code (e.g., QR code, barcode, alphanumeric code, or the like) is located on both ends of all four sides of the plastic pallet 300, which enables convenient lookup by a suitable scanner (e.g., line of sight or visual scanner, such as a QR scanner or barcode scanner) regardless of how obscured the sides of the pallet 300 are. As such, the codes are located on (or visible from) outer surfaces of the pallet.

In further detail, there are a number of ways to integrate a coded system into or onto pallets (such as plastic pallets) for individual pallet identification, tracking, and maintenance. For example, in some embodiments, after pallet manufacturing, the code is attached (e.g., adhered, printed, embossed, etched, or the like) to the pallet at one or several locations. These locations can include top, bottom, or sides of the pallet. In some such embodiments, the code is attached on all four sides, such as to ease the scanning process. For another example of coded system integration, in some embodiments, the code is engrained (e.g., 3D printed, pressed, or the like) in the pallet during pallet manufacturing. This helps prevent removal of the code. As with the after-manufacturing options, this can be done at a variety of locations, such as one or more locations at various visible points on the pallet. In some embodiments, the coded systems are readable by visual scanners, such as by reflecting visible or near visible (e.g., near infrared or long-wave ultraviolet) electromagnetic radiation off the codes and scanning the reflected patterns.

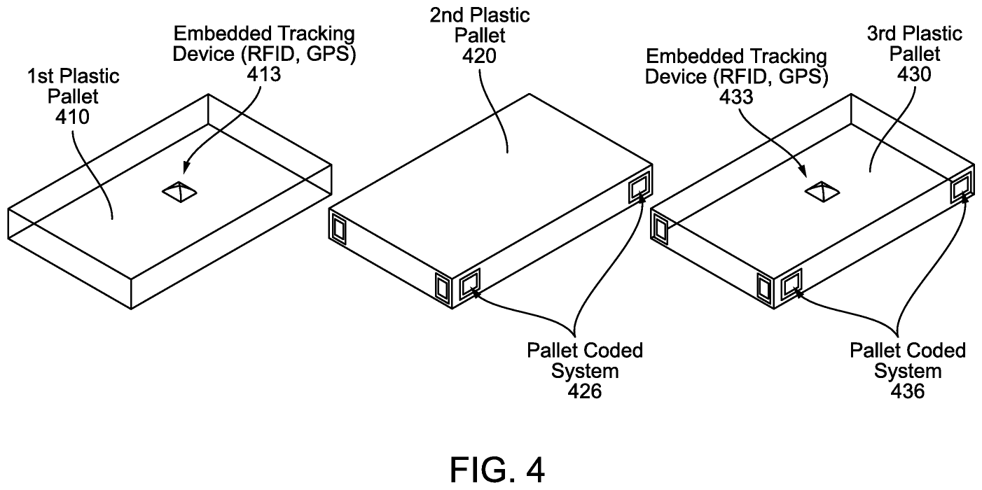

FIG. 4 is an oblique view of three example plastic pallets 410, 420, and 430 having different combinations of embedded tracking devices and pallet coded systems, suitable for use with a plastic pallet tracking and locating system such as the plastic pallet tracking and locating system 100 of FIG. 1, according to an embodiment. In particular, first plastic pallet 410 includes an embedded tracking device 413 (e.g., RFID, GPS, or the like), second plastic pallet 420 includes a pallet coded system 426 (e.g., QR code, barcode, alphanumeric code, or the like), and third plastic pallet 430 includes both an embedded tracking device 433 and a pallet coded system 436. The two technologies (tracking device and coded system) can be used independently of one another, or in parallel, or both independently and in parallel, if desired.

In further detail, FIG. 4 illustrates different smart pallet technologies. In combination with a pallet tracking and locating system (such as the plastic pallet tracking and locating system 100 of FIG. 1), the first, second, and third plastic pallets 410, 420, and 430, respectively, carry with them a user-discoverable usage history and set of pallet attributes. For instance, the smart pallets can be scanned (e.g., by a suitable scanning device, such as an RFID scanner, a QR scanner, or a barcode scanner) by the user. The results of the scan are passed to the pallet tracking and locating system, which maintains a pallet database of all of the properly-identified pallets managed by the system. The pallet tracking and locating system is configured (e.g., by code) to maintain a history of use and a set of attributes of each pallet in the pallet database. The system updates the pallet database to reflect the latest use of each pallet.

Attributes stored in the pallet database include one or more of unique identifier, pallet material, pallet manufacturer and model, pallet size, present location, present custodian, age or manufacturing date, availability, present load or product on the pallet, present destination, number of trips, number of cleanings, number of repairs, number of inspections, distance travelled, product time on pallet, and the like. Usage history of each pallet managed by the system and maintained in the pallet database include one or more of information on each trip (e.g., starting and ending times and locations, load or product, custodian, incidents, and the like), and information on each maintenance (e.g., when and what performed, such as cleaning, inspection, repair, and the like), to name a few.

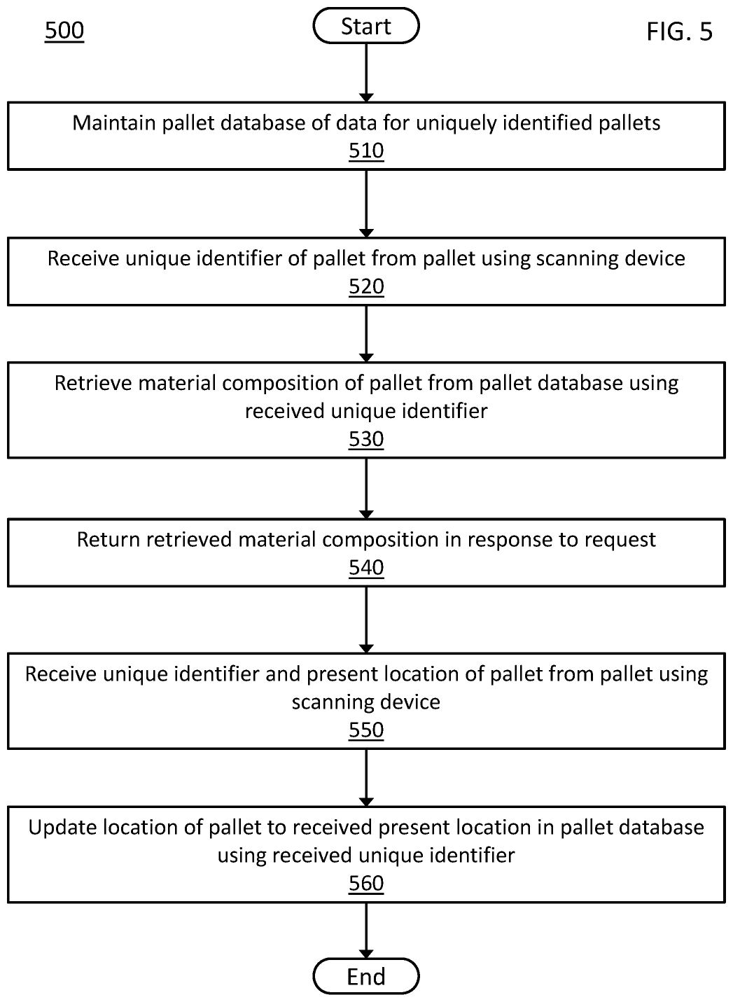

FIG. 5 is a flow diagram of an example automated pallet tracking method 500 for tracking a plurality of uniquely identified pallets (such as pallets 130, 210, 220, 300, 410, 420, or 430), according to an embodiment. For example, the pallets are uniquely identified by an embedded tracking device (such as embedded tracking device 135, 215, 225, 413, or 433) or identifier code (such as pallet code 310, 426, or 436), and their identity can be electronically scanned by a corresponding electronic scanning device (such as scanner 140).

Some or all of the method 500 (and any other method described herein) can be performed using components and techniques illustrated in FIGS. 1 through 4. Portions of this and other methods disclosed herein can be performed on or using a custom or preprogrammed logic device, circuit, or processor, such as a programmable logic circuit (PLC), computer, software, or other circuit (e.g., ASIC, FPGA) configured by code or logic to carry out their assigned task. The device, circuit, or processor can be, for example, a dedicated or shared hardware device (such as a laptop, a single board computer (SBC), a workstation, a tablet, a smartphone, part of a server, or a dedicated hardware circuit, as in an FPGA or ASIC, or the like), or computer server, or a portion of a server or computer system. The device, circuit, or processor can include a non-transitory computer readable medium (CRM, such as read-only memory (ROM), flash drive, or disk drive) storing instructions that, when executed on one or more processors, cause portions of the method 500 (or other disclosed method) to be carried out. It should be noted that in other embodiments, the order of the operations can be varied, and that some of the operations can be omitted. Some or all of the method 500 can also be performed using logic, circuits, or processors located on or in electrical communication with a platform configured to carry out the method 500.

In the example method 500, processing begins with the step of maintaining 510, on a non-transitory storage medium (e.g., disk drive, flash memory, or the like), a pallet database (such as pallet database 120) of data concerning the pallets, the data concerning each pallet being accessible by the unique identifier of the pallet and comprising a material composition (e.g., plastic, wood, to name a few) of the pallet, among other data. The method 500 further includes the step of receiving 520, by a tracking circuit (such as server 110, or a computer processor or microprocessor), the unique identifier of one of the pallets from the one of the pallets using a scanning device. The method 500 further includes the step of retrieving 530, by the tracking circuit, the material composition of the one of the pallets from the pallet database using the received unique identifier. The method 500 further includes the step of returning 540, by the tracking circuit, the retrieved material composition in response to a request (such as a request by a user for a pallet of a specific material, or a request by a recycler to determine what process to use to recycle the pallet).

The method 500 further includes the step of receiving 550, by the tracking circuit, the unique identifier and a present location (e.g., geographical location) of the one of the pallets from the one of the pallets using the scanning device. The method 500 further includes the step of updating 560, by the tracking circuit, the location of the one of the pallets to the received present location in the pallet database using the received unique identifier. For instance, the method 500 can be used as part of a location history of the pallet, which maintains location histories (e.g., date or time ranges and corresponding locations).

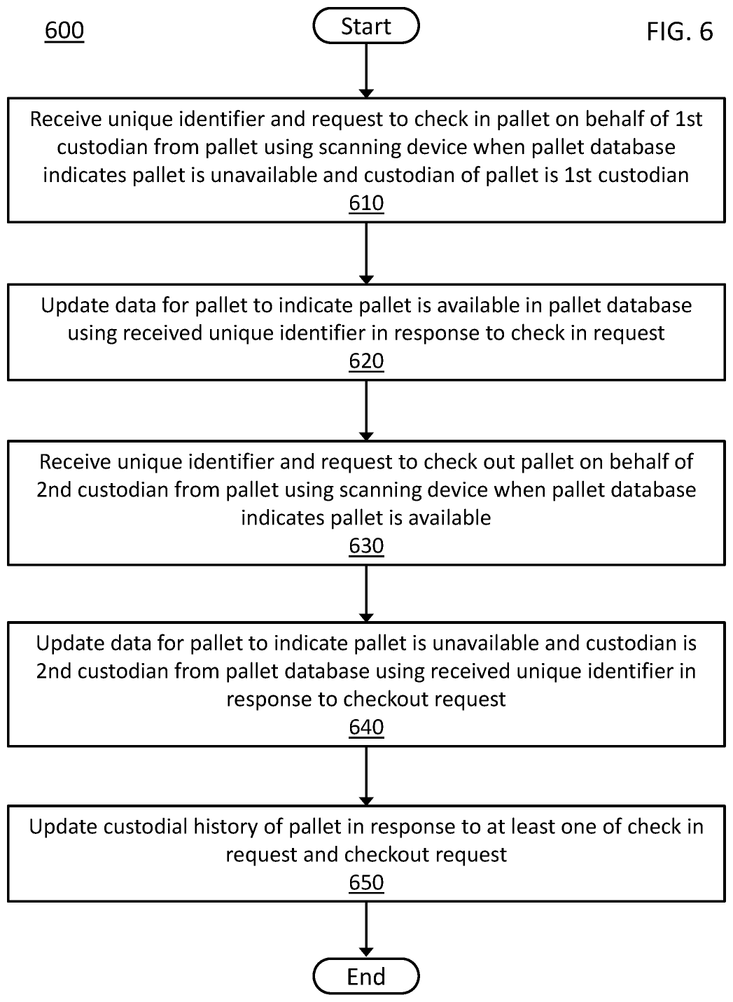

FIG. 6 is a flow diagram of an example automated pallet sharing method 600 for sharing uniquely identified pallets with a plurality of custodians (e.g., different users sharing a pool of pallets), according to an embodiment. The plurality of custodians comprises at least a first custodian and a second custodian. The data concerning each pallet further comprises an availability indicator and a custodian of the pallet from among the plurality of custodians. In some embodiments, these may be combined in a single field (e.g., using a custodian value of none to indicate that the pallet is available, and otherwise using a real custodian value to indicate the pallet is unavailable and checked out to the custodian corresponding to the real custodian value). For ease of description, the pallet sharing method 600 is described with reference to the steps or components of the pallet tracking method 500 where convenient.

In the example method 600, processing begins with the step of receiving 610, by the tracking circuit, the unique identifier and a request to check in the one of the pallets on behalf of the first custodian. The unique identifier comes (e.g., is scanned) from the one of the pallets using the scanning device when the pallet database indicates the one of the pallets is unavailable and the custodian of the one of the pallets is the first custodian. The method 600 further includes the step of updating 620, by the tracking circuit, the data concerning the one of the pallets to indicate the one of the pallets is available in the pallet database using the received unique identifier in response to the check-in request.

The method 600 further includes the step of receiving 630, by the tracking circuit, the unique identifier and a request to check out the one of the pallets on behalf of the second custodian. This unique identifier comes (e.g., is scanned) from the one of the pallets using the scanning device when the pallet database indicates the one of the pallets is available. The method 600 further includes the step of updating 640, by the tracking circuit, the data concerning the one of the pallets to indicate the one of the pallets is unavailable and the custodian is the second custodian in the pallet database using the received unique identifier in response to the checkout request.

In the method 600, the data concerning each pallet (in the pallet database) further comprises a custodial history (e.g., date or time ranges and their corresponding users or custodians) of the pallet. The method 600 further includes the step of updating 650, by the tracking circuit, the custodial history of the one of the pallets in response to at least one of the check-in request and the checkout request.

In certain embodiments in accordance with the disclosure, the custodial history can be processed by an analysis module comprising code which configures a processor to determine whether a pallet has reached the end of its usable service life and to mark the pallet after check in as being unavailable as a function of that determination. The assessment of whether a given pallet has reached the end of its usable service life can be determined programmatically by an algorithm executing in a processor configured to receive data concerning the pallet, such as the health of the pallet, the number of times it was cleaned, the number of trips in which it has been utilized, and the loads on given trips, and to output an objective determination of whether the pallet is to be retired. In part, this assessment can take into consideration the material of the pallet itself and its current proximity to a suitable recycling center, such that a limited number of additional check-outs are permitted in order to more efficiently locate the pallet near an appropriate recycling facility.

The methods described herein may be performed in part or in full by software or firmware in machine readable form on a tangible (e.g., non-transitory) storage medium. For example, the software or firmware may be in the form of a computer program including computer program code adapted to perform some or all of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It is further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

1. A pallet tracking system for tracking material compositions of a plurality of uniquely identified pallets, the pallet tracking system comprising:
a non-transitory storage device configured to maintain a pallet database of data concerning the pallets, the data concerning each pallet being accessible by the unique identifier of the pallet and comprising a material composition of the pallet, the material composition being a portion of the data concerning the pallet and identifying a structural material from which the pallet itself is made; and
a tracking circuit configured to
receive the unique identifier of one of the pallets from the one of the pallets using a scanning device,
retrieve the material composition of the one of the pallets from the pallet database using the received unique identifier, and
return the retrieved material composition in response to a request.

2. The pallet tracking system of claim 1, wherein:
the one of the pallets comprises a radio-frequency identification (RFID) tracking device embedded in the one of the pallets and configured to transmit the unique identifier of the one of the pallets; and
the scanning device is configured to receive the transmitted unique identifier from the RFID tracking device.

3. The pallet tracking system of claim 1, wherein:
the one of the pallets comprises the unique identifier embedded in the one of the pallets; and
the scanning device is configured to scan the embedded unique identifier using a line-of-sight scanner that scans reflected electromagnetic radiation off the embedded unique identifier in the visible or near visible spectrums.

4. The pallet tracking system of claim 1, wherein the data concerning the pallets comprises:
a first unique identifier whose material composition is a first plastic; and
a second unique identifier whose material composition is a second plastic different from the first plastic.

5. The pallet tracking system of claim 1, wherein the data concerning the pallets comprises:
a first unique identifier whose material composition is a first plastic composite; and
a second unique identifier whose material composition is a second plastic composite different from the first plastic composite.

6. The pallet tracking system of claim 1, wherein:
the data concerning each pallet further comprises a location of the pallet; and
the tracking circuit is further configured to
receive the unique identifier and a present location of the one of the pallets from the one of the pallets using the scanning device, and
update the location of the one of the pallets to the received present location in the pallet database using the received unique identifier.

7. The pallet tracking system of claim 6, wherein:
the data concerning each pallet further comprises a location history of the pallet; and
the tracking circuit is further configured to update the location history of the one of the pallets in response to the received present location.

8. The pallet tracking system of claim 6, wherein:
the one of the pallets comprises a radio navigation-satellite service (RNSS) tracking device embedded in the one of the pallets and configured to transmit the unique identifier and the present location of the one of the pallets; and
the scanning device is configured to receive the transmitted unique identifier and present location from the RNSS tracking device.

9. A pallet sharing system for sharing the pallets with a plurality of custodians using the pallet tracking system of claim 1, wherein:
the plurality of custodians comprises a first custodian and a second custodian;
the data concerning each pallet further comprises an availability indicator and a custodian of the pallet from among the plurality of custodians; and
the tracking circuit is further configured to
receive the unique identifier and a request to check in the one of the pallets on behalf of the first custodian from the one of the pallets using the scanning device when the pallet database indicates the one of the pallets is unavailable and the custodian of the one of the pallets is the first custodian,
update the data concerning the one of the pallets to indicate the one of the pallets is available in the pallet database using the received unique identifier in response to the check-in request,
receive the unique identifier and a request to check out the one of the pallets on behalf of the second custodian from the one of the pallets using the scanning device when the pallet database indicates the one of the pallets is available, and
update the data concerning the one of the pallets to indicate the one of the pallets is unavailable and the custodian is the second custodian in the pallet database using the received unique identifier in response to the checkout request.

10. The pallet sharing system of claim 9, wherein:
the data concerning each pallet further comprises a custodial history of the pallet; and
the tracking circuit is further configured to update the custodial history of the one of the pallets in response to at least one of the check-in request and the checkout request.

11. An automated pallet tracking method for tracking material compositions of a plurality of uniquely identified pallets, the pallet tracking method comprising:
maintaining, on a non-transitory storage medium, a pallet database of data concerning the pallets, the data concerning each pallet being accessible by the unique identifier of the pallet and comprising a material composition of the pallet, the material composition being a portion of the data concerning the pallet and identifying a structural material from which the pallet itself is made;
receiving, by a tracking circuit, the unique identifier of one of the pallets from the one of the pallets using a scanning device;
retrieving, by the tracking circuit, the material composition of the one of the pallets from the pallet database using the received unique identifier; and
returning, by the tracking circuit, the retrieved material composition in response to a request.

12. The pallet tracking method of claim 11, wherein the one of the pallets comprises a radio-frequency identification (RFID) tracking device embedded in the one of the pallets, and the pallet tracking method further comprises:
transmitting, by the RFID tracking device, the unique identifier of the one of the pallets; and
receiving, by the scanning device, the transmitted unique identifier from the RFID tracking device.

13. The pallet tracking method of claim 11, wherein:
the one of the pallets comprises the unique identifier embedded in the one of the pallets; and
the pallet tracking method further comprises scanning, by the scanning device, the embedded unique identifier using a line-of-sight scanner that scans reflected electromagnetic radiation off the embedded unique identifier in the visible or near visible spectrums.

14. The pallet tracking method of claim 11, wherein the data concerning the pallets comprises:
a first unique identifier whose material composition is a first plastic; and
a second unique identifier whose material composition is a second plastic different from the first plastic.

15. The pallet tracking method of claim 11, wherein the data concerning the pallets comprises:
a first unique identifier whose material composition is a first plastic composite; and
a second unique identifier whose material composition is a second plastic composite different from the first plastic composite.

16. The pallet tracking method of claim 11, wherein the data concerning each pallet further comprises a location of the pallet, and the pallet tracking method further comprises:
receiving, by the tracking circuit, the unique identifier and a present location of the one of the pallets from the one of the pallets using the scanning device; and
updating, by the tracking circuit, the location of the one of the pallets to the received present location in the pallet database using the received unique identifier.

17. The pallet tracking method of claim 16, wherein:
the data concerning each pallet further comprises a location history of the pallet; and
the pallet tracking method further comprises updating, by the tracking circuit, the location history of the one of the pallets in response to the received present location.

18. The pallet tracking method of claim 16, wherein the one of the pallets comprises a radio navigation-satellite service (RNSS) tracking device embedded in the one of the pallets, and the pallet tracking method further comprises:
transmitting, by the RNSS tracking device, the unique identifier and the present location of the one of the pallets; and
receiving, by the scanning device, the transmitted unique identifier and present location from the RNSS tracking device.

19. An automated pallet sharing method for sharing the pallets with a plurality of custodians using the pallet tracking method of claim 11, wherein:
the plurality of custodians comprises a first custodian and a second custodian;
the data concerning each pallet further comprises an availability indicator and a custodian of the pallet from among the plurality of custodians; and
the pallet sharing method comprises:
receiving, by the tracking circuit, the unique identifier and a request to check in the one of the pallets on behalf of the first custodian from the one of the pallets using the scanning device when the pallet database indicates the one of the pallets is unavailable and the custodian of the one of the pallets is the first custodian;
updating, by the tracking circuit, the data concerning the one of the pallets to indicate the one of the pallets is available in the pallet database using the received unique identifier in response to the check-in request;
receiving, by the tracking circuit, the unique identifier and a request to check out the one of the pallets on behalf of the second custodian from the one of the pallets using the scanning device when the pallet database indicates the one of the pallets is available; and
updating, by the tracking circuit, the data concerning the one of the pallets to indicate the one of the pallets is unavailable and the custodian is the second custodian in the pallet database using the received unique identifier in response to the checkout request.

20. The pallet sharing method of claim 19, wherein:
the data concerning each pallet further comprises a custodial history of the pallet; and
the pallet sharing method further comprises updating, by the tracking circuit, the custodial history of the one of the pallets in response to at least one of the check-in request and the checkout request.
